(19) United States
(12) Patent Application Publication
(10) Pub. No.: US 2008/0243999 A1
(43) Pub. Date: Oct. 2, 2008

(54) METHOD AND SYSTEM FOR MANAGEMENT OF AN APPLICATION ENSEMBLE

(75) Inventors: Rajesh S. Pazhyannur, Lake Zurich, IL (US); Gaurav S. Gupta, Schaumburg, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/046,528

(22) Filed: Mar. 12, 2008

Related U.S. Application Data
(60) Provisional application No. 60/908,351, filed on Mar. 27, 2007.

(51) Int. Cl. G06F 9/445; G06F 15/16

(52) U.S. Cl. 709/203; 717/177

(57) ABSTRACT

A method and a communication system having an Application Ensemble Service server is provided that manage an application ensemble having multiple applications running on one or more user terminals. The communication system allows a user to collectively transfer the ensemble from a source terminal or terminals to a target terminal or terminals, for example, from voice and data terminals to other voice and data terminals or to a single user terminal. The communication system further allows the user to selectively transfer applications of the ensemble, such as transferring only the voice session from the voice terminal to another voice or voice/data terminal, and to copy an ensemble, or a portion of an ensemble, from a source terminal to a target terminal, wherein the ensemble or portion of the ensemble is not removed from the source terminal. The communication system further allows a user to suspend and resume an application ensemble.

### CROSS-REFERENCE TO RELATED APPLICATION

This application claims priority from provisional application Ser. No. 60/908,351, entitled “METHOD AND APPARATUS FOR MANAGEMENT OF AN APPLICATION ENSEMBLE,” filed Mar. 27, 2007, which is commonly owned and incorporated herein by reference in its entirety.

### FIELD OF THE INVENTION

The present invention relates generally to Internet Protocol Multimedia Subsystem (IMS)-based communication systems, and, in particular, to creating and managing an ensemble of applications in an IMS-based communication system.

### BACKGROUND OF THE INVENTION

As communication systems and networking software have advanced, it is now possible for users to participate in meetings remotely. That is, instead of physically convening in a same location, meeting participants may connect to the meeting remotely, running a voice session on a wireline voice terminal, such as a conventional telephone or a cordless telephone, or on a wireless voice terminal such as a cellular telephone, while running meeting software, such as Microsoft® NetMeeting®, on a data terminal such as a personal computer or a laptop computer. In addition, remote meeting participants may communicate textually via data applications, such as a Short Message Service (SMS) or an Instant Messenging service, and, via NetMeeting, may share data applications running on the data terminals such as Microsoft® Word® and Microsoft® Excel®. Situations may arise where a remote participant may need or desire to change locations and may want to take the meeting with him or her or to suspend participation in the meeting and resume participation in the meeting on different voice and/or data terminals.

Further, when a user is at work, the user may be running one or more Microsoft® Office® applications, such as Word® or Excel®, as well as NetMeeting®, Windows Explorer®, and Instant Messenger®, on the user's personal computer and voice and/or video on a desk phone. When the user leaves the office, the user may desire to continue one or more of these applications on a smartphone or personal digital assistance (PDA) with a wireless interface.

Currently, in order to transfer multiple applications from a source terminal to a target terminal, a user must treat every application individually. In addition, the prior art does not provide for common management of multiple applications running on multiple terminals as part of a single user's participation in a multimedia session. Further, any suspension, or transfer to a target terminal, of an application involved in a multimedia session at a source terminal must be performed by a user at the source terminal.

Therefore, a need exists for a method and system of transferring voice and data applications running on one or more data and/or voice terminals to other data and/or voice terminals that is simple for a user to execute and provides a nearly seamless experience to the user.

### BRIEF DESCRIPTION OF THE DRAWINGS

FIG. 1 is a block diagram of a wireless communication system in accordance with an embodiment of the present invention.

FIG. 2 is a block diagram of a user terminal of FIG. 1 in accordance with an embodiment of the present invention.

FIG. 3 is a block diagram of a user terminal of FIG. 1 in accordance with another embodiment of the present invention.

FIG. 4 is a block diagram of an Application Ensemble Service (AES) server of FIG. 1 in accordance with an embodiment of the present invention.

FIG. 5A is a signal flow diagram that illustrates a transfer of an application ensemble that is running on a first multiple user terminals to another user terminal in accordance with an embodiment of the present invention.

FIG. 5B is a continuation of the signal flow diagram of FIG. 5A that illustrates a transfer of an application ensemble that is running on a first multiple user terminals to another user terminal in accordance with an embodiment of the present invention.

FIG. 6A is an exemplary logic flow diagram illustrating a suspension of an application ensemble by an AES client of a user terminal in accordance with an embodiment of the present invention.

FIG. 6B is a continuation of the logic flow diagram of FIG. 6A illustrating a suspension of an application ensemble by an AES client of a user terminal in accordance with an embodiment of the present invention.

FIG. 7 is an exemplary logic flow diagram illustrating a resumption of an application ensemble by an AES client of a user terminal in accordance with an embodiment of the present invention.

FIG. 8A is a signal flow diagram that illustrates a pulling of an application ensemble by a user terminal from one or more other user terminals in accordance with another embodiment of the present invention.

FIG. 8B is a continuation of the signal flow diagram of FIG. 8A that illustrates a pulling of an application ensemble by a user terminal from one or more other user terminals in accordance with another embodiment of the present invention.

FIG. 9 is a signal flow diagram that illustrates a suspension of an application ensemble by a user terminal and a transfer of the suspended ensemble to another user terminal in accordance with another embodiment of the present invention.

FIG. 10 is a signal flow diagram that illustrates a resumption of a suspended voice session that is part of an application ensemble in accordance with another embodiment of the present invention.

FIG. 11 is a signal flow diagram that illustrates a pulling of an application ensemble by a user terminal from another user terminal in accordance with another embodiment of the present invention.

FIG. 12 is an exemplary logic flow diagram that illustrates a pulling of an application ensemble by a target user terminal from a source user terminal, from the perspective of the user terminals, in accordance with another embodiment of the present invention.

FIG. 13 is a signal flow diagram that illustrates a copying of one or more applications of an application ensemble from a source user terminal to a target user terminal without removing the copied applications from the ensemble at the source user terminal in accordance with an embodiment of the present invention.

FIG. 14 is a signal flow diagram that illustrates a transfer of a voice session from one voice terminal to another voice terminal in accordance with an embodiment of the present invention, wherein the voice session is part of an application ensemble.

One of ordinary skill in the art will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION OF THE INVENTION

To address the need for a method and system of transferring voice and data applications running on one or more data and/or voice terminals to other data and/or voice terminals that is simple for the user to execute and provides a nearly seamless experience to the user, a method and a communication system having an Application Ensemble Service (AES) server is provided that manage an application ensemble having multiple applications running on one or more user terminals. The communication system allows a user to collectively transfer the ensemble from a source terminal or terminals to a target terminal or terminals, for example, from voice and data terminals to other voice and data terminals or to a single user terminal. The communication system further allows the user to selectively transfer applications of the ensemble, such as transferring only the voice session from the voice terminal to another voice or voice/data terminal, and to copy an ensemble, or a portion of an ensemble, from a source terminal to a target terminal, wherein the ensemble or portion of the ensemble is not removed from the source terminal. The communication system further allows a user to suspend and then resume an application ensemble.

Generally, an embodiment of the present invention encompasses a method for management of an application ensemble comprising multiple applications. The method includes concurrently running the multiple applications on multiple user terminals associated with a same user, collecting ensemble information for the multiple applications, transferring the ensemble information to a user terminal different from the multiple user terminals, and opening, by the user terminal different from the multiple user terminals, the multiple applications based on the ensemble information.

Another embodiment of the present invention encompasses a method for management of an application ensemble comprising multiple applications. The method includes concurrently running multiple applications on one or more user terminals associated with a same user, initiating, by a user terminal different from the one or more user terminals, a transfer of the multiple applications, and transferring the multiple applications to the user terminal different from the one or more user terminals.

Yet another embodiment of the present invention encompasses an apparatus for managing an application ensemble comprising multiple applications. The apparatus comprises a network server configured to collect ensemble information for multiple applications concurrently running on multiple user terminals associated with a same user and transfer the ensemble information to a user terminal different from the plurality of user terminals.

Still another embodiment of the present invention encompasses an apparatus for managing an application ensemble comprising multiple applications concurrently running on one or more user terminals associated with a same user. The apparatus comprises a network server configured to receive, from a user terminal different from the one or more user terminals, a request to initiate a transfer of the plurality of applications and transfer the plurality of applications to the user terminal different from the one or more user terminals.

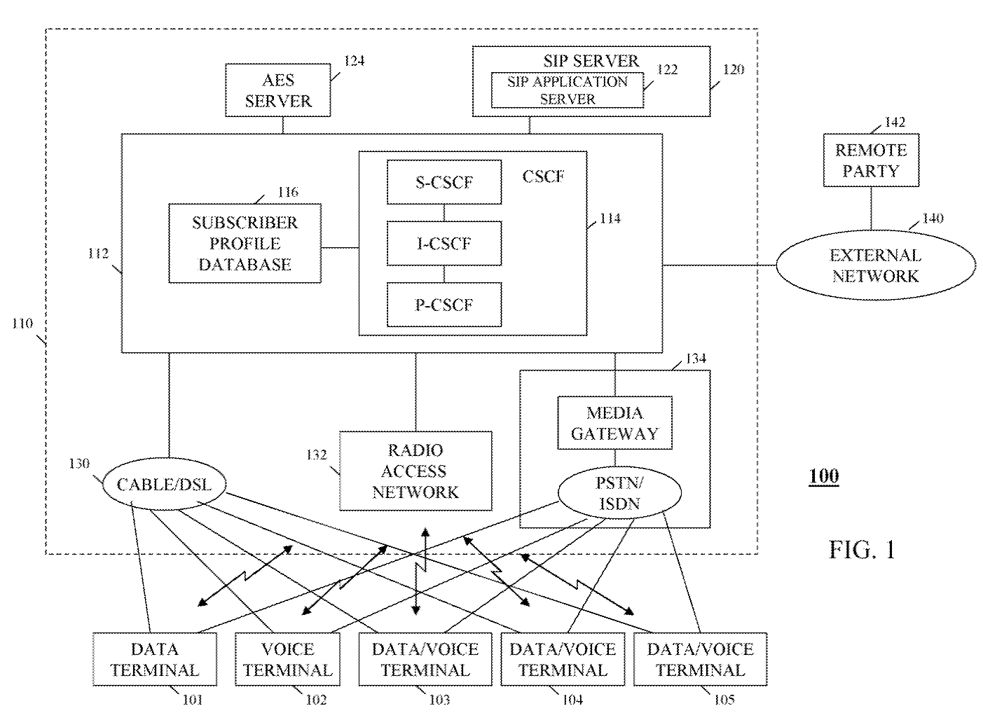

The present invention may be more fully described with reference to FIGS. 1-14. FIG. 1 depicts a block diagram of an Internet Protocol Multimedia Subsystem (IMS)-based communication system 100 in accordance with an embodiment of the present invention. Communication system 100 may operate in accordance with any one of a variety of wireless and wireline communication systems delivering Internet Protocol (IP)-based multimedia communication services over multiple telecommunications networks.

Communication system 100 comprises multiple user terminals 101-105 (five shown), which also may be referred to herein as communication devices, that are each in communication with an infrastructure, or network, 110. A first user terminal 101 of the multiple user terminals 101-105 is a computer-based device, such as a personal computer or a laptop computer, capable of running data applications stored in a memory device of the computer, for example, Microsoft® Office® applications, such as Word® or Excel®, as well as NetMeeting®, Windows Explorer®, Instant Messenger®, and a Short Message Service (SMS), and includes an Application Ensemble Service (AES) client capable of communicating with an AES server of infrastructure 110. A second user terminal 102 of the multiple user terminals 101-105 is a voice-capable device, such as a desktop telephone, a cordless telephone, or a mobile station that supports voice calls. However, first user terminal 101 may further support voice calls and second user terminal 102 may further support data applications. A third, fourth, and fifth user terminal 103-105 of the multiple user terminals 101-105 each supports data applications and voice sessions, such as a personal computer or a laptop computer with voice capability or a third generation (3G) mobile station, such as a smartphone or a Personal Digital Assistant (PDA) with wireless voice capabilities, for example, a Motorola® Q® available from Motorola, Inc., of Schaumburg, Ill., and also includes an AES client capable of communicating with the AES server.

When executing data applications, user terminals 101-105 may communicate with infrastructure 110 via any air interface that supports data transfers, such as a GPRS, CDMA 2000, or UMTS wireless link with data capabilities, or a wideband wireline link. When executing voice applications, user terminals 101-105 may communicate with infrastructure 110 via any air interface that supports voices sessions, such as a second generation (2G), 2.5G, or 3G wireless link, for example, a GSM, CDMA, GPRS, CDMA 2000, or UMTS wireless link, or a conventional wireline link.

Infrastructure 110 is an Internet Protocol Multimedia Subsystem (IMS)-based system and includes an IMS core network 112 comprising a Call Session Control Function (CSCF) 114 that implements one or more of a Proxy CSCF (P-CSCF), a Serving CSCF (S-CSCF), and an Interrogating CSCF (I-CSCF). CSCF 114 serves as a centralized routing engine, policy manager, and policy enforcement point to facilitate the delivery of multiple real-time applications using IP transport. It is application-aware and uses dynamic session information to manage network resources (feature servers, media gateways, and edge devices) and to provide advance allocation of these resources depending on the application and user context. The I-CSCF is the contact point within an operator's network for all connections destined for a user of that network, or for a roaming user currently located within that network's service area. The S-CSCF is responsible for identifying the user's service privileges, selecting access to an application server coupled to the IMS network, and providing access to those servers. The P-CSCF is the SIP signaling contact point in the IMS core network for a user terminal such as user terminals 101-105. The P-CSCF is responsible for forwarding SIP registration messages from a subscriber's endpoint, that is, from a User Element of a user terminal in a visited network to the I-CSCF and for subsequent call set-up requests and responses to the S-CSCF. P-CSCF maintains a mapping between a logical subscriber SIP Uniform Resource Identifier (URI) address and a physical User Element IP address and a security association for both authentication and confidentiality.

Infrastructure 110 further includes multiple application servers, and in particular an AES server 124 and a Session Initiation Protocol (SIP) server 120 that comprises a SIP application server 122. Each of SIP server 120 and AES server 124 is coupled to IMS core network 112, and in particular to Call Session Control Function (CSCF) 114 and is further coupled to a subscriber profile database 116, such as a Home Subscriber Server (HSS) or a User Profile Service Function (UPSF). SIP servers are well known in the art and will not be described in greater detail herein. AES server 124 is a Session Initiation Protocol (SIP) entity that hosts and executes services and can operate in a number of modes, such as a SIP User Agent terminating function. AES server 124 further includes or is in communication with a conference bridge platform that includes a conference bridge that may be utilized by the AES server to set up a conference call.

When an AES client requests to transfer an application ensemble, AES server 124 may modify the transfer, for example, by modifying a file associated with one or more applications being transferred or by blocking a transfer of one or more applications or files, based on policies stored on the server by a system operator or based on a profile of a user associated with a source user terminal or a target user terminal, which profiles may be downloaded by the S-CSCF from a subscriber profile database, such as subscriber profile database 130, during registration of the user terminal (via well-known registration procedures) and retrieved by AES server 124 from the S-CSCF or which profile may be downloaded directly by the AES server 124 during the registration.

Infrastructure 110 further provides for an exchange of data and signaling between infrastructure 110 and an end user, such as user terminals 101-105, via any one of multiple wireless and wireline access networks 130, 132, 134. For example, as depicted in FIG. 1, infrastructure 110 is capable of communicating with user terminals 101-105 via a fixed broadband access network 130, a radio access network (RAN) 132, and a conventional wireline network 134. RAN 132 may comprise a Third Generation Partnership Project (3GPP) access network comprising one or more controllers (not shown), such as radio network controllers (RNCs) or a base station controllers (BSCs), coupled and one or more transceivers (not shown), such as Node Bs or base transceiver stations (BTSs). Conventional wireline network 134 may comprise a public or enterprise wireline network, such as a Public Switched Telephone Network (PSTN) or an Integrated Services Digital Network (ISDN), and a media gateway, such as one or more of a Media Gateway Function (MGF), Signaling Gateway Function (SGF), and Border Gateway Function (BGF), that interfaces between the IMS core network and wireline network 288.

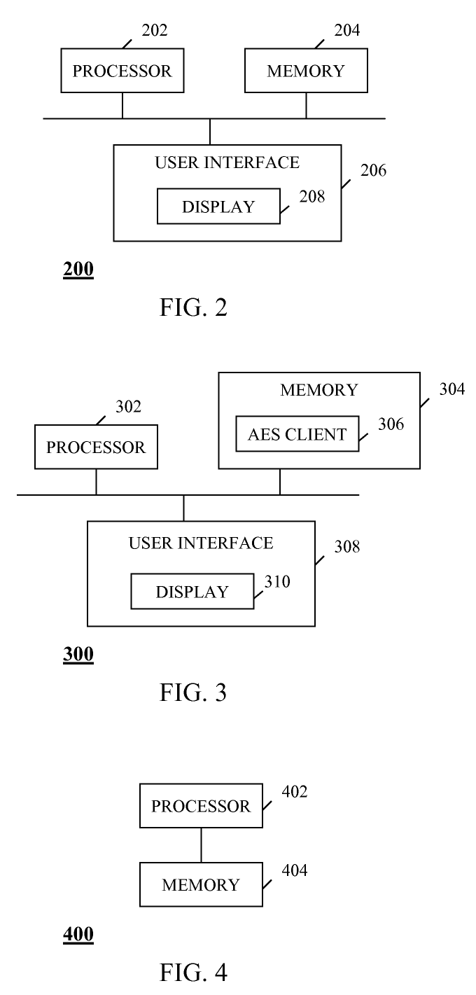

FIG. 2 is a block diagram of a voice terminal 200, such as user terminal 102, in accordance with an embodiment of the present invention. Voice terminal 200 includes a processor 202, such as one or more microprocessors, microcontrollers, digital signal processors (DSPs), combinations thereof or such other devices known to those having ordinary skill in the art. Voice terminal 200 further includes at least one memory device 204 associated with the processor, such as random access memory (RAM), dynamic random access memory (DRAM), and/or read only memory (ROM) or equivalents thereof, that stores data and programs, such as Session Initiation Protocol (SIP)-related programs, that may be executed by the processor and that allow the user terminal to perform all functions necessary to operate in communication system 100. Voice terminal 200 further includes a user interface 206. User interface 206 provides an interface with a user of the user terminal whereby the user may input information into the user terminal or receive information output by the user terminal and may include one or more of audio input and output interfaces, a keyboard, and a display screen 208, which display screen may have touch screen capability.

FIG. 3 is a block diagram of a data or a data and voice terminal 300, such as user terminals 101 and 103-105, in accordance with another embodiment of the present invention. Data/voice terminal 300 includes a processor 302, such as one or more microprocessors, microcontrollers, digital signal processors (DSPs), combinations thereof or such other devices known to those having ordinary skill in the art. Data/voice terminal 300 further includes at least one memory device 304 associated with the processor, such as random access memory (RAM), dynamic random access memory (DRAM), and/or read only memory (ROM) or equivalents thereof, that stores data and programs, such as Session Initiation Protocol (SIP)-related programs, that may be executed by the processor and that allow the user terminal to perform all functions necessary to operate in communication system 100. Data/voice terminal 300 further maintains, in at least one memory device 304, instructions for implementing an AES client 306, which instructions are executed by processor 302. AES client 306 comprises application layer functionality that interfaces with an application layer of AES server 124 and exchanges application layer messages with the AES server. Preferably, AES client 306 communicates with AES server 124 via an SIP/UDP (User Datagram Protocol)/IP, an SIP/TCP (Transmission Control Protocol)/IP, a UDP/SIP, or a TCP/IP protocol. Further, the information elements exchanged between AES client 306 and AES server 124, as described below, may be expressed in an XML file. Data/voice terminal 300 further includes a user interface 308. User interface 308 provides an interface with a user of the terminal whereby the user may input information into the user terminal or receive information output by the user terminal and may include one or more of audio input and output interfaces, a keyboard, and a display screen 310, which display screen may have touch screen capability.

FIG. 4 is a block diagram of AES server 124 in accordance with an embodiment of the present invention. AES server 124 includes a processor 402, such as one or more microprocessors, microcontrollers, digital signal processors (DSPs), combinations thereof or such other devices known to those having ordinary skill in the art. AES server 124 further includes at least one memory device 404 associated with the processor, such as random access memory (RAM), dynamic random access memory (DRAM), and/or read only memory (ROM) or equivalents thereof, that store data and programs, such as Session Initiation Protocol (SIP)-related programs, that may be executed by the processor and that allow the AES server to perform all functions necessary to operate in communication system 100. At least one memory device 404 may further maintain operator policies concerning applications that may or may not be transferred among user terminals or any modifications that should be made to such applications before the applications are transferred. For example, when an ensemble is transferred from a laptop to a mobile station, and the ensemble contains a Microsoft® NetMeeting® application that is not supported by the mobile station, then the NetMeeting application should not be transferred.

At least one memory device 404 further stores a profile for each user subscribed to the services of communication system 100. Each profile includes a list of user terminals registered by that user, for example, an identifier associated with each such device. For example, a profile of a user associated with user terminal 101 may further include identifiers associated with each of user terminals 102-105. The profile may further include a list of communication devices that the user has permission to access, for example, to copy applications to or from or to transfer applications to or from such devices. By storing associations among all user terminals registered to a user or that a user has permission to access, a user accessing AES server 124 via one of the devices registered to that user may be able to retrieve a list of application ensembles created by any of the other devices registered by, or accessible by, that user. In the sense of being associated with each other, such associated user terminals may also be thought of as related user terminals. In another embodiment of the present invention, the profiles of the users may be maintained in subscriber profile database 116 and may be downloaded from the subscriber profile database and stored by AES server 124 whenever needed.

The embodiments of the present invention preferably are implemented within each of user terminals 101-105 and AES server 124, and more particularly with or in software programs and instructions stored in the at least one memory devices and executed by the processors of the user terminals and AES server. However, one of ordinary skill in the art realizes that the embodiments of the present invention alternatively may be implemented in hardware, for example, integrated circuits (ICs), application specific integrated circuits (ASICs), and the like, such as ASICs implemented in the user terminals or AES server, and all references to ‘means for’ herein may refer to any such implementation of the present invention. Based on the present disclosure, one skilled in the art will be readily capable of producing and implementing such software and/or hardware without undo experimentation.

Communication system 100 allows a user to collectively transfer an application ensemble running on one or more source user terminals to one or more target user terminals. An application ensemble comprises a collection of end-user applications that may be specified by the user. For example, when a user is at work, his or her ensemble may be a collection of one or more of a voice and/or a video application running on a voice terminal and one or more data applications running on a data terminal such as a personal computer. The one or more data applications may include, but is not limited to, any one or more of the following applications: Microsoft® NetMeeting®, Microsoft® Office® applications such as Word® or Excel®, Windows Explorer®, Instant Messenger®, and Windows Media Player®, a Short Message Service (SMS), and Windows Media Player®. By way of another example, when a user is on a cellular telephone, an application ensemble may comprise a voice application and an Internet Browser.

Communication system 100 then allows the user to collectively transfer the ensemble from a source terminal or terminals to a target terminal or terminals, for example, from voice and data terminals to other voice and data terminals or to a single user terminal such as a voice/data terminal, for example, a smartphone or a PDA with wireless voice capabilities. Communication system 100 further allows the user to selectively transfer applications of the ensemble, such as transferring only the voice session from the voice terminal to another voice or voice/data terminal, and to copy an ensemble, or a portion of an ensemble, from a source terminal to a target terminal, wherein the ensemble or portion of the ensemble is not removed from the source terminal. Communication system 100 further allows a user to suspend and then resume an application ensemble. Suspension of an ensemble comprises shutting down all applications in the ensemble. In the case of voice and video, suspension comprises terminating a connection. Resume then comprises automatically starting the applications in a context that is the same as the context when the applications were suspended. For example, a Word application would be resumed with the same word documents that were open at the time of suspension. By way of another example, resumption of a NetMeeting application comprises connecting the application to the same NetMeeting connection at the time of suspension. By way of yet another example, resumption of a voice/video application comprises connecting the user's end terminal to the same party that the user was in communication with at the time that the application was suspended. Further, in order to clarify the principles of the present invention, it is sometimes assumed herein that a multimedia communication session involving an application ensemble is set up between a local user utilizing the one or more of user terminals 101-105 and a remote party 142 via an external network 140 (or the remote party may, instead, utilize any one or more of access networks 130, 132, and 134) and that the local user then may transfer, copy, or suspend and resume the locally-executed ensemble. Thus, communication system 100 provides the local user with a simple and seamless ability to take the multimedia communication session with him or her when changing locations, for example, when leaving an office and continuing the session in his/her car or at his/her home. In order to facilitate the management of an application ensemble, communication system 100 further provides an AES server 124 that operates in infrastructure 110 and that manages a transfer of an application ensemble, or a portion of an ensemble, from one or more of source user terminals to one or more target user terminals.

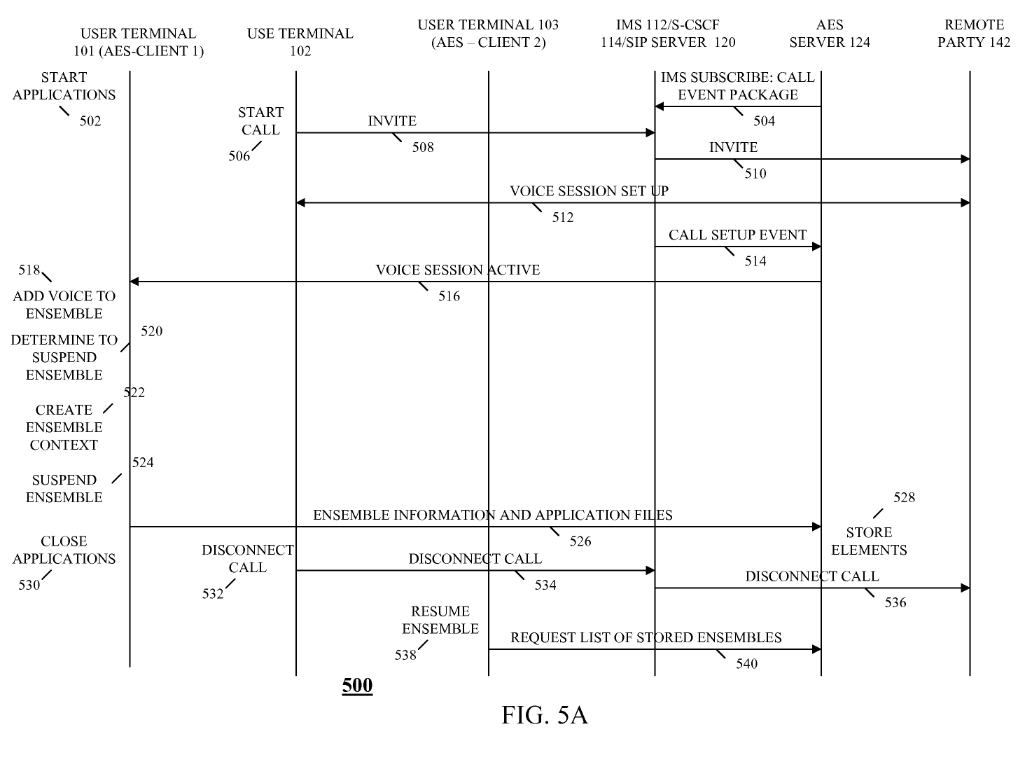

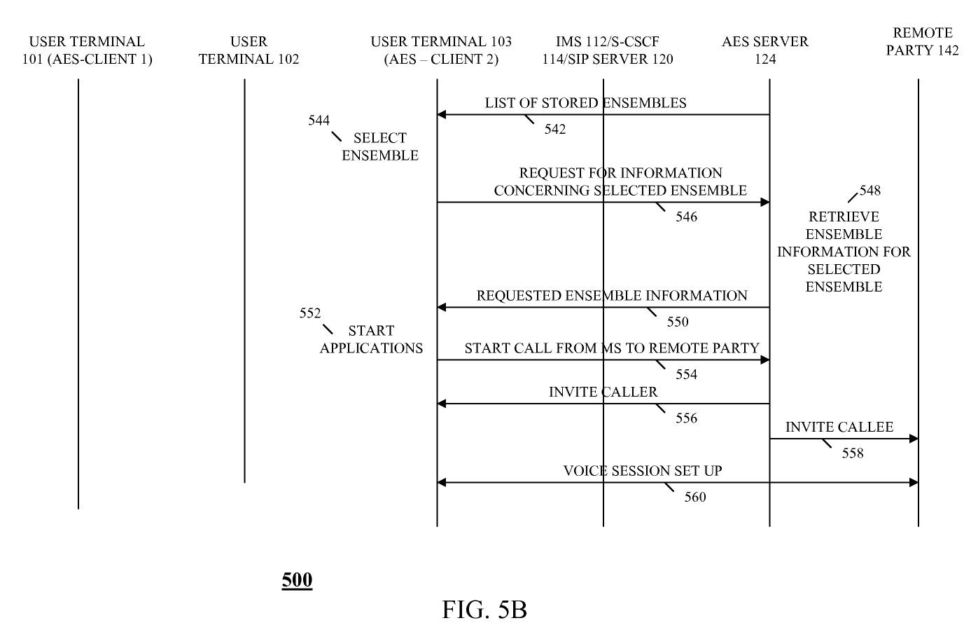

Referring now to FIGS. 5A and 5B, a signal flow diagram 500 is provided that illustrates a transfer of an application ensemble that is running on a first multiple user terminals, such as voice terminal and a data terminal, to another user terminal, such as a user terminal capable of supporting voice and data applications, for example, a wireless user terminal such as a smartphone or a PDA with wireless voice capabilities, in accordance with an embodiment of the present invention. Signal flow diagram 500 begins when a local user starts up a multimedia session with remote party 142. More particularly, the user starts (502, 506) an ensemble comprising one or more data applications, for example, Microsoft® NetMeeting®, Word®, Excel®, Windows® Media Player®, and Instant Messenger®, on a first user terminal 101 and a call to remote party 142 on a second user terminal 102. Concurrent with, or prior to, starting up the multimedia session, AES server 124 requests (504) that CSCF 114, and in particular the S-CSCF, inform the AES server of any call event involving user terminal 102. Preferably, the request by AES server 124 comprises an IMS SUBSCRIBE: CALL EVENT PACKAGE message that identifies user terminal 102, preferably by conveying an identifier associated with the user terminal, and that requests information concerning any call event involving the user terminal.

In response to the user of user terminal 102 initiating the call, user terminal 102 conveys (508), to IMS core network 112, a session invitation, preferably a SIP INVITE, intended for remote party 142. The session invitation is routed to SIP server 120 and the SIP server forwards (510) the session invitation to remote party 142. When the remote party accepts the session invitation, a voice session is then set up (512) in accordance with well-known techniques, and CSCF 114, and in particular the S-CSCF, informs (514) AES server 124 that a call has been set up between user terminal 102 and remote party 142. Preferably, CSCF 114 informs AES server 124 of the call by conveying a CALL SETUP EVENT message, preferably an IMS: EVENT: CALL message, to the AES server. The CALL SETUP EVENT message includes information pertinent to the voice call, including a source (user terminal 102) identifier and a destination (remote party 142) identifier.

In response to being informed that a voice call has been set up between user terminal 102 and remote party 142, AES server 124 then informs (516) AES client 306 of user terminal 101 of the call, preferably by conveying a VOICE SESSION ACTIVE message to user terminal 101 that informs of an active voice session between user terminal 102 and remote party 142, including providing the identifiers of user terminal 102 and remote party 142. For example, suppose that AES Client 306 of user terminal 101 is a laptop/desktop computer and user terminal 102 is a deskphone. AES Client 306 of user terminal 101, at the time of start-up of the terminal, registers with AES server 124. Upon successful registration with AES Client 306 of user terminal 101, AES Server 124 would start sending information about voice sessions (such as call-setup, call-end, etc.) involving any user terminal related to user terminal 101, such as user terminal 102, to AES client 306 of user terminal 101. In response to being informed of the voice call between user terminal 102 and remote party 142, the AES client 306 of user terminal 101 creates (518) an application ensemble by storing, in the at least one memory device of user terminal 101 and in association the data application running on the user terminal, the voice session information received from AES server 124 in association with information concerning the data applications running on user terminal 101.

For example, the user of user terminal 101 may input an instruction to create an application ensemble or AES client 306 of user terminal 101 may prompt the user of the user terminal to indicate whether the user wishes to create an application ensemble. In response to receiving an instruction to create the ensemble, the AES client 306 of user terminal 101 displays, on a display screen 310 of the user terminal, a list of applications running on the user terminal and further including the voice session running on user terminal 102. The user of user terminal 101 may then select, from the list, the applications that the user wishes to include in the application ensemble. In response to receiving the user's selection, the AES client 306 of user terminal 101 stores, in at least one memory device 304 and in association with each other, information elements that identify the selected applications and that further include a context of each such application, such as a state of each such application or associated file. For example, context information may include context elements such as, with respect to NetMeeting, whether the netmeeting was started by the AES client/user terminal or whether the AES client/user terminal was just a participant in the NetMeeting session. If the netmeeting was started by the AES client/user terminal, then the context information may comprise a list of all participants. By way of another example, with respect to Instant Messenger (IM), context information may include context elements such as a list of currently active instant messenger sessions and addresses of participants in the sessions. By way of yet another example, with respect to Media Player, context information may include the URL (Uniform Resource Locator) of the media file being played by the media player. And by way of still another example, with respect to a voice session, context information may include context elements such as the telephone number (or SIP URI) of the remote party.

At some point during the multimedia session, the local user, that is, the user of user terminals 101 and 102, may decide to transfer the active application ensemble. The user of user terminal 101 then inputs, into user terminal 101, an instruction to suspend the application ensemble. For example, the user may select a softkey displayed on the display screen 310 of the client device indicating a desire to suspend the ensemble. When the user inputs an instruction to suspend the ensemble, the AES client 306 may then display, on a display screen 310 of the user terminal, a list of the applications included in the ensemble. The user of user terminal 101 may then select, from the list, the applications that the user wishes to suspend, or AES client 306 may automatically determine to suspend all applications in the ensemble without querying the user for a selection.

In response to receiving the user's suspend instruction, or further in response to receiving the user's selection of applications to suspend, the AES client 306 of user terminal 101 determines (520) to suspend the selected applications and creates (522) an ensemble context comprising ensemble information elements. The AES client 306 further suspends (524) each of the applications in the ensemble, or at least the selected applications if a selection is made. As referred to herein, ensemble information elements identify the applications to be suspended and include context elements associated with each such application and any associated file, such as a current state of each such application and/or file, for example, a current copy of a file (word document) being displayed in Microsoft Word or a current copy of a file (spreadsheet) being displayed in Microsoft Excel. AES client 306 of user terminal 101 then conveys (526) the ensemble information elements to AES server 124 and further may upload, to the AES server or another known network repository, open files, for example, a Word document, an Excel spreadsheet, or a Windows Media file, if such files are not included in the ensemble information elements. AES client 306 of user terminal 101 then closes (530) the applications being transferred on user terminal 101.

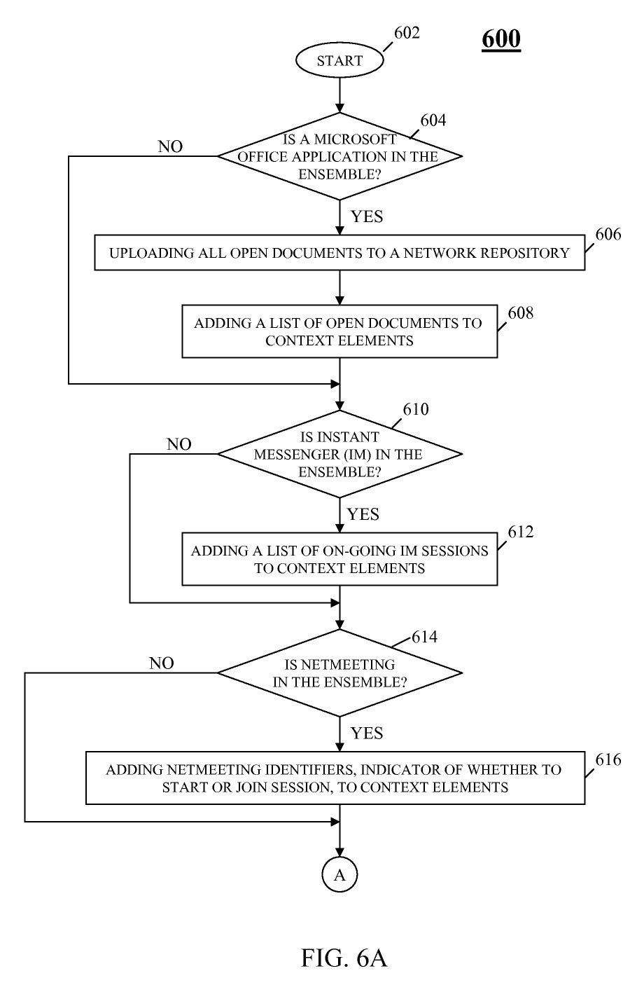

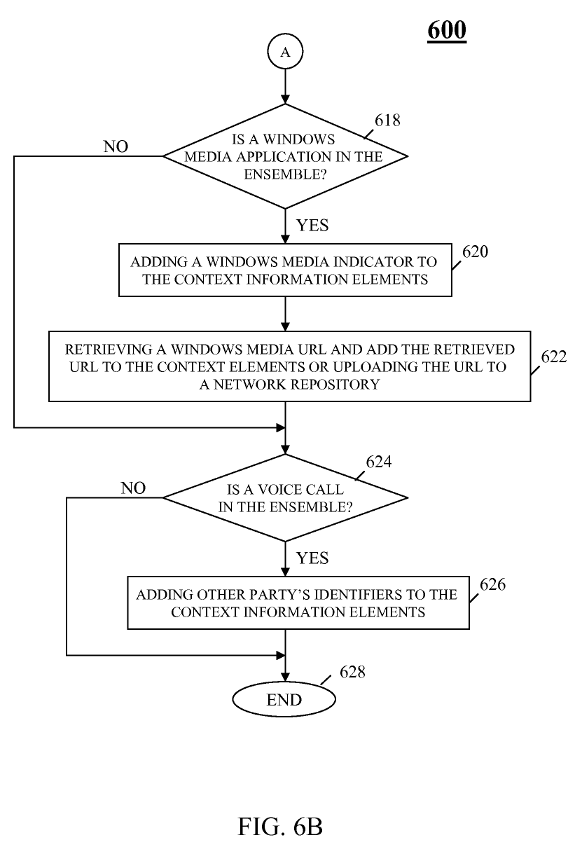

For example, FIGS. 6A and 6B are an exemplary logic flow diagram 600 illustrating a suspension of an application ensemble by an AES client 306, such as AES client 306 of user terminal 101, in accordance with an embodiment of the present invention. Logic flow diagram 600 begins (602) when an AES client 306 of a user terminal, such as AES client 306 of user terminal 101, determines (604, 610, 614, 618, 624) whether the ensemble includes one or more of multiple voice and data applications, for example, a Microsoft Office product, such as Microsoft Word of Microsoft Excel, an Instant Messenger (IM) application, a NetMeeting application, a Windows Media application, and a voice application.

If Microsoft Office applications are included in the ensemble, AES client 306 of user terminal 101 may include open documents in transferred ensemble information or may transfer (606) all open documents to AES server 124 or another known network repository. The AES client 306 further may add (608) a list of the open documents to the context elements so that a target user terminal receiving the context elements knows which documents to retrieve from the repository. If IM is included in the ensemble, the AES client 306 may add (612) a list of on-going IM sessions to the context elements and further retrieve the IM addresses of the current parties to the IM session and store those addresses as well at the network repository. If the ensemble includes, a NetMeeting application, the AES client 306 may add (616) NetMeeting identifiers to the context elements and add an indicator of whether the user terminal, that is, user terminal 101, is the NetMeeting host. If the user terminal is not the NetMeeting host, then the AES client 306 may store the address of the NetMeeting host at the network repository. If the user terminal is the NetMeeting host, then all addresses of the connected parties may be retrieved by the AES client 306 and stored, by the AES client, at the network repository. If the ensemble includes a Windows Media application, the AES client 306 may add (620) a Windows Media indicator to the context elements. The AES client 306 further may retrieve (622) a Windows Media Uniform Resource Locator (URL) and add the retrieved URL to the context elements or store the retrieved URL at the network repository. If the URL is on the local user terminal, then the user of the terminal may be prompted by the AES client as to whether the file should also be transferred to the network repository. These items may be retrieved by the AES client 306 and transferred to the network repository. If the ensemble includes a voice application, the AES client 306 may add (626), to the context elements, identifiers of the other parties to the call. Logic flow 600 then ends (628).

Referring again to FIG. 5, in response to receiving the ensemble information elements from user terminal 101, AES server 124 stores (528) the ensemble information elements in at least one memory device 404 and in association with user terminal 101. AES server 124 may further store time and date of creation information associated with the ensemble, and any other identifying information that may occur to one of ordinary skill in the art, so that a user may be able to distinguish various ensembles from each other when multiple ensembles are included in a list of stored ensembles.

In addition, the user of user terminal 102 instructs (532) the user terminal to disconnect the call, in response to which user terminal 102 conveys (534) a disconnect call message to IMS core network 112, and in particular to CSCF 114, that identifies remote party 142 and that includes an instruction to terminate the call. In response to receiving the disconnect message from user terminal 102, CSCF 114 conveys (536) a disconnect call message to remote party 142 and the call between user terminal 102 and remote party 142 is terminated in accordance with well-known call termination techniques, which includes disconnection of the call and closing of the voice application at user terminal 102.

After requesting user terminal 101 to suspend the application ensemble and further disconnecting the call at user terminal 102, the local user powers up a third user terminal 103 and inputs (538) an instruction into user terminal 103 to resume the application ensemble. User terminal 103 routes the instruction to AES client 306 of the user terminal and, in response to receiving the instruction, the AES client 306 of user terminal 103 conveys (540), to AES server 124, a request for a list of stored ensembles. In response to receiving the request for a list of stored ensembles, AES server 124 searches at least one memory device 404 for all application ensembles stored in association with any communication device associated with user terminal 103. AES server 124 then compiles a list of all such ensembles and conveys (542) the compiled list of ensembles back to AES client 306 of user terminal 103, which list includes the application ensemble uploaded to AES server 124 by user terminal 101. In compiling the list, AES server 124 may include any information stored in association with each listed ensemble in order to distinguish the ensemble from other listed ensembles, such as a time and date of creation. The list may further include, for each listed ensemble, an identifier, such as an index value, that is unique to that ensemble (relative to the other ensembles in the list) and that is assigned to the ensemble by AES server 124, which identifier may be used to identify that ensemble from among all ensembles in the list.

In one embodiment of the present invention, the associations among the user terminals 101-105, as well as the associations between each such user terminal and an application ensemble created by the user terminal, may be maintained by AES server 124. In another embodiment of the present invention, the associations among the user terminals 101-105 may be maintained by subscriber profile database 116 while the list of associations between each such user terminal and an application ensemble created by the user terminal may be maintained by AES server 124. In the latter embodiment, AES server 124 retrieves a list of associated user terminals from the subscriber profile database 116 and then compiles a list of application ensembles associated with a user terminal based on the list of associated user terminals retrieved from the subscriber profile database.

In response to receiving the list of ensembles from AES server 124, AES client 306 of user terminal 103 displays the list to the user of the user terminal via display screen 310 and receives (544) a selection of an ensemble in the list of ensembles from the user. In response to receiving the selection, AES client 306 of user terminal 103 conveys (546) a request for information concerning the selected ensemble to AES server 124. In response to receiving the request, AES server 124 retrieves (548), from at least one memory device 404, the ensemble information stored with respect to the selected ensemble and conveys (550) the retrieved ensemble information to AES client 306 of user terminal 103. In response to receiving the ensemble information, which comprises ensemble information elements that include context elements, AES client 306 of user terminal 103 instructs (552) the user terminal to start up the applications identified in the ensemble information and to start up, and to download if necessary, any associated files based on the ensemble information elements.

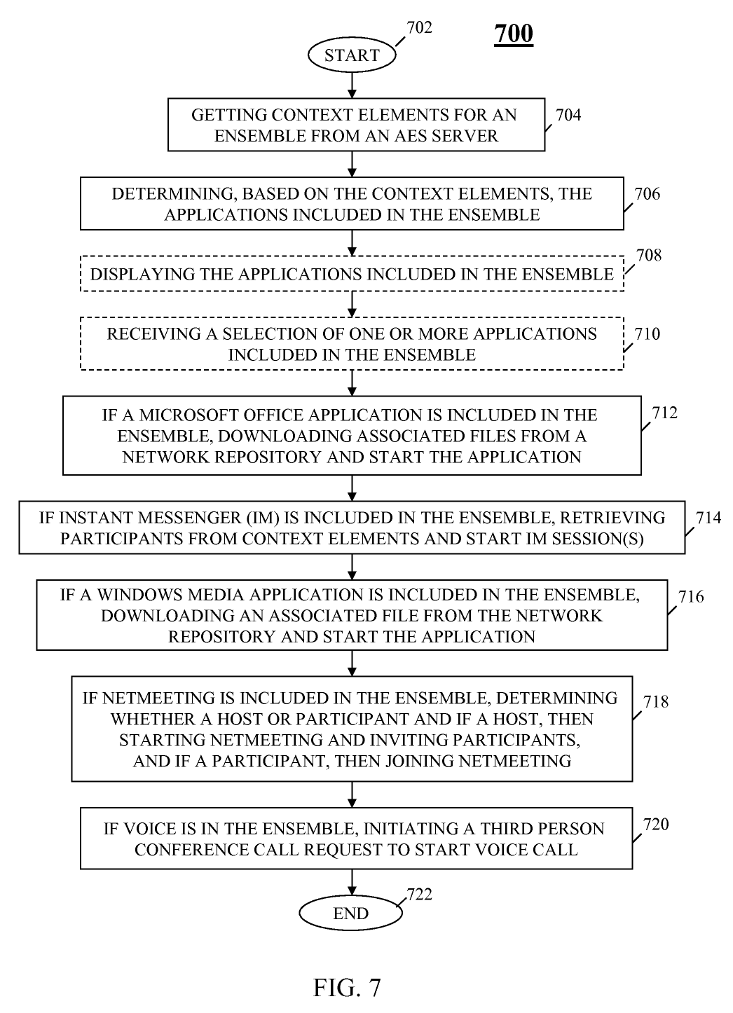

For example, FIG. 7 is an exemplary logic flow diagram 700 illustrating a resumption of an application ensemble by an AES client 306, such as AES client 306 of user terminal 103, in accordance with an embodiment of the present invention. Logic flow diagram 700 begins (702) when an AES client 306 of a user terminal, such as AES client 306 of user terminal 101, obtains (704) ensemble information that comprises ensemble information elements, including context elements, for an application ensemble from AES server 122. AES client 306 then determines (706), based on the ensemble information elements, and may display (708), on a display screen 310 of the associated user terminal, all applications included in the ensemble. The user of the user terminal may then input (710), to the user terminal, a selection of the applications to be resumed/opened. AES client 306 of the user terminal further may determine whether any files will need to be downloaded if the file is not included in the received ensemble information.

For example, AES client 306 may determine (712) whether the ensemble includes a Microsoft Office application, such as Word or Excel. If the ensemble includes a Microsoft Office application (and, in each examplary instance herein, the user desires to resume/open such application given such a choice), AES client 306 may, based on the received context elements, download an associated file or files (for example, a Word document or an Excel spreadsheet) from the network repository, that is, AES server 122, if the file is not available locally and starts up the application. AES client 306 further may determine (714) whether the ensemble includes an Instant Messenger (IM) application. If the ensemble includes an IM application, then AES client 306 may retrieve a list of participants from the received context elements and start one or more IM sessions.

AES client 306 further may determine (716) whether the ensemble includes a Windows Media application. If the ensemble includes a Windows Media application, AES client 306 may download the file from the network repository if the file is not available locally. AES client 306 further may determine (718) whether the ensemble includes a NetMeeting application. If the ensemble includes a NetMeeting application, AES client 306 may determine whether the associated user terminal is supposed to host the NetMeeting and, if the user terminal comprising the AES client is the NetMeeting host, then the AES client may retrieve all addresses of the connected parties from the network repository and may restart the NetMeeting. If the user terminal comprising the AES client is not the NetMeeting host, then the AES client/user terminal may retrieve the address of the NetMeeting host and simply join the meeting. AES client 306 further may determine (720) whether the ensemble includes a voice application. If the ensemble includes a voice application, the AES client 306 may initiate a third party conference call request to start a voice call. Logic flow 700 then ends (722).

In addition, based on the received ensemble information, AES client 306 of user terminal 103 identifies remote party 142 and instructs (554) AES server 124 to resume the voice session with the remote party, that is, to start a call between user terminal 103 and remote party 142. In response to receiving the instruction, AES server 124 invites (556, 558) each of user terminal 103 and remote party 142 to a voice communication session, preferably by conveying a SIP INVITE message to each of the user terminal and the remote party. A voice session is then set up (560) in accordance with well known techniques and signal flow diagram 500 ends.

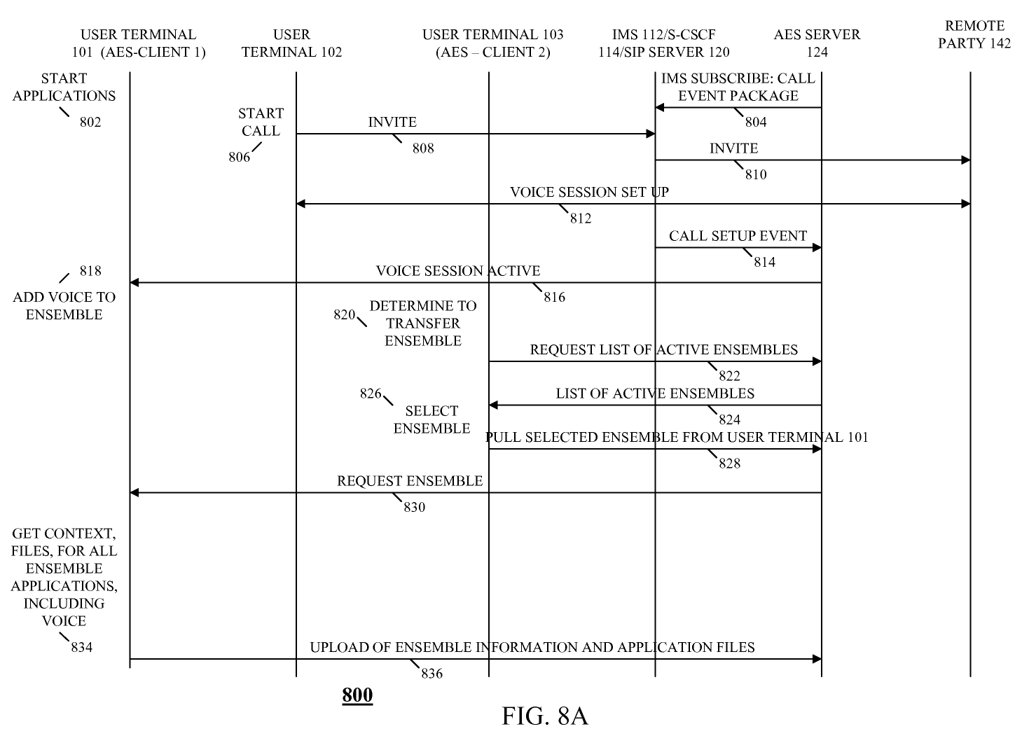

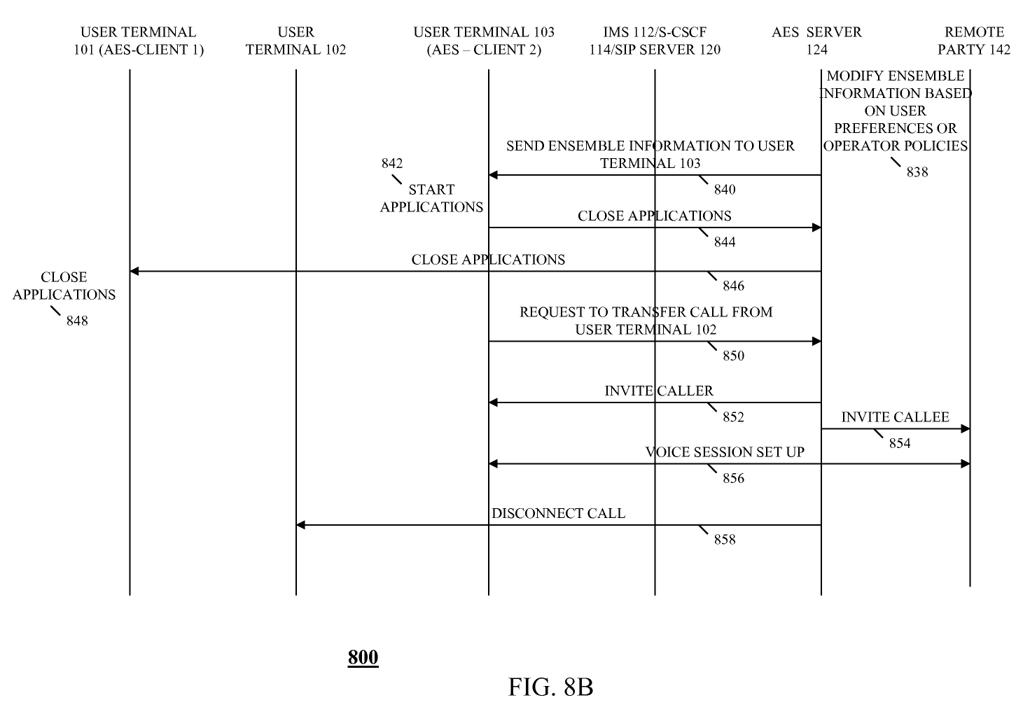

Referring now to FIGS. 8A and 8B, a signal flow diagram 800 is provided that illustrates a pulling of an application ensemble by a user terminal from one or more other user terminals in accordance with another embodiment of the present invention. Similar to signal flow diagram 500, signal flow diagram 800 begins when a local user starts up a multimedia session with remote party 142. More particularly, the user starts up (802) one or more data applications, for example, Microsoft® NetMeeting®, Word®, Excel®, Instant Messenger®, and Media Player®, on a first user terminal 101 and initiates (806) a call to remote party 142 on a second user terminal 102. Concurrent with, or prior to, the starting up of the multimedia session, AES server 124 requests (804) that CSCF 114, and in particular the S-CSCF, inform the AES server of any call event involving a related user terminal, such as user terminal 102. Preferably, the request by AES server 124 comprises an IMS SUBSCRIBE: CALL EVENT PACKAGE message that identifies user terminal 102, preferably by conveying an identifier associated with the user terminal, and that requests information concerning any call event involving the user terminal.

In response to the user of user terminal 102 initiating the call, user terminal 102 conveys (808), to IMS core network 112, a session invitation, preferably a SIP INVITE, intended for remote party 142. The session invitation is routed to SIP server 120 and the SIP server forwards (810) the session invitation to remote party 142. When the remote party accepts the session invitation, a voice session is then set up (812) in accordance with well-known techniques, and CSCF 114, and in particular the S-CSCF, informs (814) AES server 124 that a call has been set up between user terminal 102 and remote party 142. Preferably, CSCF 114 informs AES server 124 of the call by conveying a CALL SETUP EVENT message, preferably an IMS: EVENT: CALL message, to the AES server. The CALL SETUP EVENT message includes information pertinent to the voice call, including a source (user terminal 102) identifier and a destination (remote party 142) identifier.

In response to being informed that a voice call has been set up between user terminal 102 and remote party 142, AES server 124 then informs (816) user terminal 101 of the call, preferably by conveying a VOICE SESSION ACTIVE message to user terminal 101 that informs of an active voice session between user terminal 102 and remote party 142, including providing the identifiers of user terminal 102 and remote party 142. In response to being informed of the voice call between user terminal 102 and remote party 142, the AES client 306 of user terminal 101 creates (818) an application ensemble by storing, in the at least one memory device of user terminal 101 and in association the data applications running on the user terminal, the voice session information received from AES server 124. In addition, in creating the ensemble, AES client 306 of user terminal 101 stores, in at least one memory device 304 and in association with each other, context elements that identify the selected applications and that concern a context of each such application and/or an associated file, such as a state of each such application and/or file as described in detail above.

At some point during the multimedia session, a user, for example, the user of user terminals 101 and 102, may decide (820) to pull the active application ensemble to a third user terminal 103. That is, the user may initiate, from user terminal 103 instead of user terminal 101, the transfer of the application ensemble. In such an instance, the user instructs AES client 306 of user terminal 101 to suspend the ensemble applications pending at user terminal 101, in response to which the AES client suspends (830) the applications. In addition, after powering up user terminal 103, the user of user terminal 103 inputs, into user terminal 103, an instruction to transfer an application ensemble. For example, the user may select a softkey displayed on the display screen 310 of the client device indicating a desire to transfer an ensemble. When the user inputs an instruction to transfer an ensemble, the AES client 306 of user terminal 103 requests (822) a list of active ensembles from AES server 124.

In response to receiving the request for a list of active ensembles, AES server 124 compiles a list of all application ensembles associated with any user terminal associated with user terminal 103 and conveys (824) the compiled list of ensembles back to AES client 306 of user terminal 103. The list of ensembles may include, for each listed ensemble, an identifier, such as an index value, that is unique to that ensemble (relative to the other ensembles in the list) and that is assigned to the ensemble by AES server 124, which identifier may be used to identify that ensemble among all ensembles in the list. In one embodiment of the present invention, AES server 124 may compile the list by searching at least one memory device 404 of the AES server for all application ensembles maintained in association with any user terminal associated with user terminal 103. That is, when an AES client 306 of a user terminal, such as user terminal 101, creates an ensemble, the AES client informs the AES server 124 of the existence of the ensemble. The existence of the ensemble is then stored by AES server 124 in at least one memory device 404. During a pull of an ensemble, AES server 124 retrieves the details of the ensemble from the user terminal, that is, user terminal 101. If there are application ensembles active on multiple AES clients 306/user terminals or the applications of an ensemble are active on multiple AES clients 306/user terminals, then AES server 124 retrieves the ensemble details from each of the multiple AES clients. In another embodiment of the present invention, an AES client 306 of a user terminal might not inform AES server 124 of the existence of an ensemble. In such an embodiment, in order to compile a list of ensembles, AES server 124 then may probe all registered AES clients 306/user terminals to check whether they have an active ensemble.

As described above, in one embodiment of the present invention, the associations among user terminals 101-105, as well as the associations between each such user terminal and an application ensemble created by the user terminal, may be maintained by AES server 124. In another embodiment of the present invention, the associations among the user terminals 101-105 may be maintained by subscriber profile database 116 while the list of ensembles associated with each such user terminal may be maintained by AES server 124. In the latter embodiment, AES server 124 retrieves a list of associated user terminals from the subscriber profile database 116 and then compiles a list of application ensembles associated any user terminal included in the list of user terminals.

In response to receiving the list of application ensembles from AES server 124, AES client 306 of user terminal 103 displays the list to the user of user terminal 103 via a display screen 310 of the user terminal and receives (826) a selection of an ensemble in the list of ensembles from the user, for example, the ensemble pending at user terminal 101. In response to receiving the selection, AES client 306 of user terminal 103 conveys (828), to AES server 124, a request for information concerning the selected application ensemble. In response to receiving the request, AES server 124 conveys (830), to AES client 306 of user terminal 101, a request to transfer the user terminal's ensemble. In response to receiving the request, AES client 306 of user terminal 101 retrieves (834) context information for all applications included in the ensemble, including the information received from AES server 124 concerning the voice session pending at user terminal 102, conveys (836) ensemble information, including ensemble information elements that include the context elements, back to AES server 124. AES client 306 of user terminal 101 further may upload, to as AES server 124 or another known network repository, files associated with the applications included in the ensemble if such files are not included in the conveyed ensemble information.

In response to receiving the ensemble information from user terminal 103, AES server 124 optionally may determine (838) whether to modify any of the ensemble information based on preferences of the user of user terminals 101, 102, and 103 or based on operator policies maintained in the at least one memory device 404 of AES server 124. The user preferences may be maintained by AES server 124 in a profile of the user or such user preferences may be maintained in a profile of the user at subscriber profile database 116 and downloaded from the database by AES server 124. For example, when an ensemble is transferred from a laptop to a mobile station, and the ensemble contains a Microsoft NetMeeting application that is not supported by the mobile station, then the NetMeeting application should not be transferred to the mobile station.

After optionally modifying (838) the ensemble information in accordance with any determined user preferences or operator policies, AES server 124 conveys (840) the ensemble information, as so modified, to AES client 306 of user terminal 103. In response to receiving the ensemble information elements, AES client 306 of user terminal 103 instructs (842) the user terminal to start up the applications identified in the ensemble information and further to open, and download if necessary, the associated files based on the ensemble information elements. In addition, AES client 306 of user terminal 103 instructs (844) AES server 124 to close the applications in the ensemble that have been suspended at user terminal 101. In response to receiving the instruction from user terminal 103, AES server 124 instructs (846) AES client 306 of user terminal 101 to close the suspended applications and, in response, AES client 306 of user terminal 101 closes (848) the applications.

In addition, based on the received ensemble information elements, AES client 306 of user terminal 103 determines that the ensemble included a voice session between user terminal 102 and remote party 142. AES client 306 of user terminal 103 conveys (850), to AES server 124, a request that the voice session be transferred to user terminal 103. In response to receiving the request, AES Server 124 invites (852, 854) each of user terminal 103 and remote party 142 to a voice communication session, preferably by conveying a SIP INVITE message to each of the user terminal and the remote party and a voice session is then set up (856) in accordance with well known techniques. AES server 124 further instructs (858) user terminal 102 to disconnect the call, in response to which the user terminal disconnects the call and closes the voice application. Signal flow diagram 800 then ends.

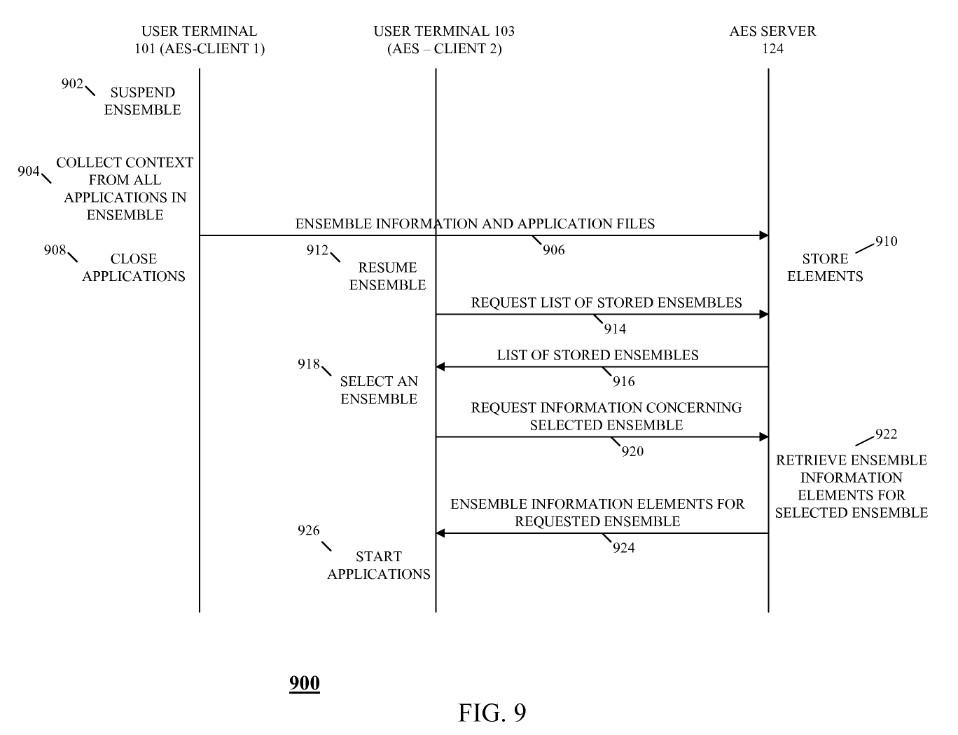

Referring now to FIG. 9, a signal flow diagram 900 is provided that illustrates a suspension of an application ensemble by a first user terminal and a transfer of the suspended ensemble to a second user terminal in accordance with another embodiment of the present invention. Signal flow diagram 900 begins when a local user who is running an ensemble of applications on a user terminal 101 decides to transfer the ensemble. The user of user terminal 101 then inputs, into user terminal 101, an instruction to transfer the application ensemble. For example, the user may select a softkey displayed on the display screen 310 of the client device indicating a desire to transfer the ensemble. When the user inputs an instruction to transfer the ensemble, the AES client 306 may then display, on a display screen 310 of the user terminal, a list of the applications included in the ensemble. The user of user terminal 101 may then select, from the list, the applications that the user wishes to transfer, or AES client 306 may automatically determine to transfer all applications in the ensemble without querying the user for a selection.

In response to receiving the user's transfer instruction, or further a selection of applications to transfer, the AES client 306 of user terminal 101 then suspends (902) the applications in the ensemble, or at least the selected applications if a selection is made. AES client 306 of user terminal 101 further determines to transfer the selected applications and collects (904) ensemble information elements that identify the applications to be transferred and that include context elements associated with each such application and associated file, such as a current state of each such application and/or file. AES client 306 of user terminal 101 then conveys (906) ensemble information, including the ensemble information elements, to AES server 124 and closes (908) the applications being transferred on user terminal 101. AES client 306 of user terminal 101 may further upload files associated with the applications included in the ensemble to AES server 124 or another known network repository if such files are not included in the conveyed ensemble information

In response to receiving the ensemble information from user terminal 101, AES server 124 stores (910) the ensemble information elements in at least one memory device 404 and in association with user terminal 101. AES server 124 may further store time and date of creation information associated with the ensemble, and any other identifying information that may occur to one of ordinary skill in the art, so that the user may be able to distinguish among stored ensembles when more than one ensemble is stored in association with the user.

After requesting that user terminal 101 transfer the application ensemble, the user powers up user terminal 103 and inputs (912) an instruction into user terminal 103 to resume the application ensemble. User terminal 103 routes the instruction to AES client 306 of the user terminal and, in response to receiving the instruction, the AES client of the user terminal conveys (914), to AES server 124, a request for a list of stored ensembles. In response to receiving the request for a list of stored ensembles, AES server 124 searches at least one memory device 404, and/or retrieves from subscriber profile database 132, information concerning all application ensembles stored in association with any user terminal associated with user terminal 103. AES server 124 then compiles a list of all such ensembles and conveys (916) the compiled list of ensembles back to AES client 306 of user terminal 103. The list of ensembles may include any information stored in association with each ensemble in order to distinguish the ensemble from other ensembles in the list, such as a time and date of creation. The list may further include, for each listed ensemble, an identifier, such as an index value, that is unique to that ensemble (relative to the other ensembles in the list) and that is assigned to the ensemble by AES server 124, which identifier may be used to identify that ensemble from among all ensembles in the list.

In response to receiving the list of ensembles from AES server 124, AES client 306 of user terminal 103 displays the list to the user of the user terminal via display screen 310 and receives (918) a selection of an ensemble in the list of ensembles from the user. In response to receiving the selection, AES client 306 of user terminal 103 conveys (920) a request for information concerning the selected ensemble to AES server 124. In response to receiving the request, AES server 124 retrieves (922), from at least one memory device 404, the ensemble information elements stored with respect to the selected ensemble and conveys (924) the retrieved ensemble information elements to AES client 306 of user terminal 103. In response to receiving the ensemble information elements, AES client 306 of user terminal 103 instructs (926) the user terminal to start up the applications identified in the ensemble information and further open the associated files based on the ensemble information elements. Signal flow diagram 900 then ends.

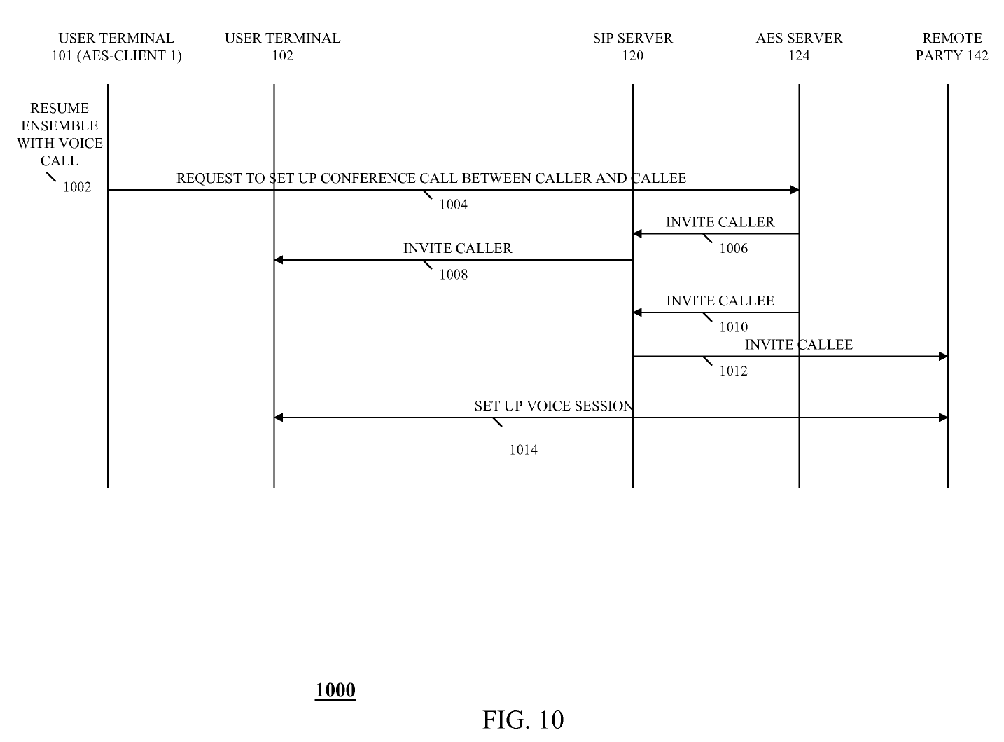

Referring now to FIG. 10, a signal flow diagram 1000 is provided that illustrates a resumption of a suspended voice session that is part of an active application ensemble in accordance with another embodiment of the present invention. Signal flow diagram 1000 assumes that AES server 124 maintains, in at least one memory device 404, an association between user terminal 101 and user terminal 102 such that when an ensemble active on user terminal 101 includes a voice session, the voice session may be executed on user terminal 102. Signal flow diagram 1000 begins when a user is running an ensemble of data applications on user terminal 101, which ensemble includes a suspended voice session. AES client 306 of user terminal 101 maintains contextual information associated with the ensemble, including an identifier associated with the voice session destination communication device, that is, remote party 142, and informs AES server 124 of the active ensemble. The user of user terminal 101 then inputs (1002) an instruction to user terminal 101 to resume the ensemble with the voice session. User terminal 101 routes the instruction to AES client 306 of user terminal 101 and the AES client conveys (1004), to AES server 124, a request to set up a third party call control initiated call with remote party 142, which request includes an identifier of the remote party.

In response to receiving the request, AES server 124 determines, by reference to at least one memory device 404 and based on the request, to route the call to both user terminal 102 and remote party 142. AES server 124 then conveys (1006) a session invitation for user terminal 102, preferably a SIP INVITE, to SIP server 120 and the SIP server forwards (1008) the session invitation to user terminal 102. AES server 124 further conveys (1010) a session invitation for remote party 142, preferably a SIP INVITE, to SIP server 120 and the SIP server forwards (1012) the session invitation to the remote party. A voice session is then set up (1014) between user terminal 102 and remote party 142 in accordance with well known techniques and signal flow diagram 1000 then ends.

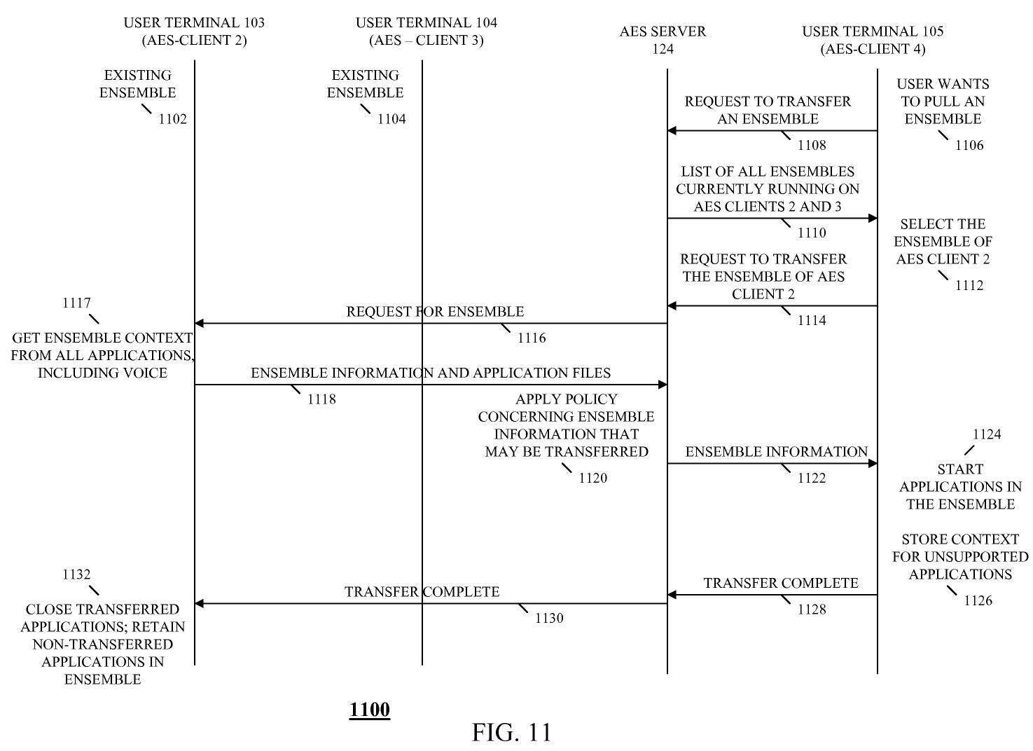

Referring now to FIG. 11, a signal flow diagram 1100 is provided that illustrates a pulling of an ensemble of applications by a target user terminal from a source user terminal in accordance with another embodiment of the present invention. Signal flow diagram 1100 begins when application ensembles are active (1102, 1104) on each of a first user terminal 103 and a second user terminal 104, for example, ensembles comprising data applications such as Microsoft® NetMeeting®, Word®, and Excel®. The ensembles may further include a voice session. A user of a third, target user terminal 105 then decides (1106) to pull an application ensemble from a source user terminal, that is, one of the first and second user terminals 103, 104. That is, the user of user terminal 105 initiates a transfer of an application ensemble from another user terminal by inputting, into user terminal 105, an request to transfer an application ensemble. For example, the user may select a softkey displayed on the display screen 310 of the user terminal indicating a desire to transfer an ensemble. When the user inputs an instruction to transfer an ensemble, the AES client 306 of user terminal 105 conveys (1108) a request, to AES server 124, to transfer an ensemble to the user terminal.

In response to receiving the request, AES server 124 searches at least one memory device 404, or retrieves from subscriber profile database 116, information concerning all application ensembles maintained in association with any user terminal associated with user terminal 105 or that the user terminal may have permission to access. AES server then compiles a list of all ensembles associated with any user terminal associated with user terminal 105 or that the user terminal may have permission to access and conveys (1110) the compiled list of ensembles back to AES client 306 of user terminal 105. The list of ensembles may include, for each listed ensemble, an identifier, such as an index value, that is unique to that ensemble (relative to the other ensembles in the list) and that is assigned to the ensemble by AES server 124, which identifier may be used to identify that ensemble from among all ensembles in the list.

As described above, in one embodiment of the present invention, in response to creating an ensemble, the AES client 306 of each user terminal 103, 104 may inform AES server 124 of the ensemble and the AES client may then store such information in at least one memory device 404. In response to receiving the request from user terminal 105, AES server 124 then may search at least one memory device 404 for all application ensembles maintained in association with any user terminal associated with user terminal 105 or that the user terminal may have permission to access. In another embodiment of the present invention, in response to receiving the request from user terminal 105, AES server 124 may probe, for application ensembles, any user terminal associated with user terminal 105 or that the user terminal may have permission to access.

Further, in an embodiment of the present invention, the associations among user terminals 103-105, as well as the associations between each such user terminal and an application ensemble created by the user terminal, may be maintained by AES server 124. In another embodiment of the present invention, the associations among the user terminals 103-105 may be maintained by subscriber profile database 116 while the list of ensembles associated with each such user terminal may be maintained by AES server 124. In the latter embodiment, AES server 124 retrieves a list of associated user terminals from the subscriber profile database 116 and then compiles a list of application ensembles associated any user terminal included in the list of user terminals.

In response to receiving the list of ensembles from AES server 124, AES client 306 of user terminal 105 displays the list to the user of the user terminal via display screen 310 of the user terminal and receives (1112), from the user, a selection of a an ensemble in the list of ensembles that is pending at a source user terminal, for example, the ensemble pending at a user terminal 103. In response to receiving the selection, AES client 306 of user terminal 105 conveys (1114), to AES server 124, a request for information concerning the selected ensemble, which request includes an identifier of the ensemble.

In response to receiving the request, AES server 124 retrieves context elements for the selected ensemble. Preferably, AES server 124 conveys (1116), to source user terminal 103, a request to transfer the ensemble pending at the user terminal. In response to receiving the request, AES client 306 of user terminal 103 retrieves (1117) ensemble information elements associated with all applications included in the ensemble, including any information received from AES server 124 concerning any pending voice sessions, and conveys (1118) the ensemble information elements back to AES server 124. AES client 306 of user terminal 103 further may upload, to AES server 124 or another known network repository, files associated with the applications, for example, a Word document, an Excel spreadsheet, or a Windows Media file.

In response to receiving the ensemble information elements from user terminal 103, AES server 124 may optionally determine (1120) whether to modify any of the ensemble information elements based on preferences associated with user terminals 103 or 105 or based on operator policies stored in the at least one memory device 404 of AES server 124. The user preferences may be maintained by AES server 124 in the profile of the user or such user preferences may be maintained by subscriber profile database 116 and downloaded from the database by AES server 124.

After optionally modifying (1120) the ensemble information elements in accordance with any determined user preferences or operator policies, AES server 124 conveys (1122) the ensemble information elements, as so modified, to AES client 306 of user terminal 105. In response to receiving the ensemble information elements, AES client 306 of user terminal 105 instructs (1124) the user terminal to start up the applications identified in the ensemble information and to open, and to download if necessary, associated files based on the ensemble information elements. In addition, AES client 306 of user terminal 105 stores (1126), in the at least one memory device 304 of the user terminal, context information for any applications in the transferred ensemble that are not supported by user terminal 105. AES client 306 of user terminal 105 then informs (1128) AES server 124 that the transfer is complete and further informs AES server 124 of the ensemble applications that are not supported by user terminal 105. In turn, AES server 124 informs (1130) AES client 306 of user terminal 103 that the transfer is complete and of the unsupported ensemble applications. AES client 306 of user terminal 103 then closes (1132) the applications transferred to, and supported by, user terminal 105 and retains, in the ensemble of active applications, the applications that are not supported by user terminal 105. Signal flow diagram 1100 then ends.

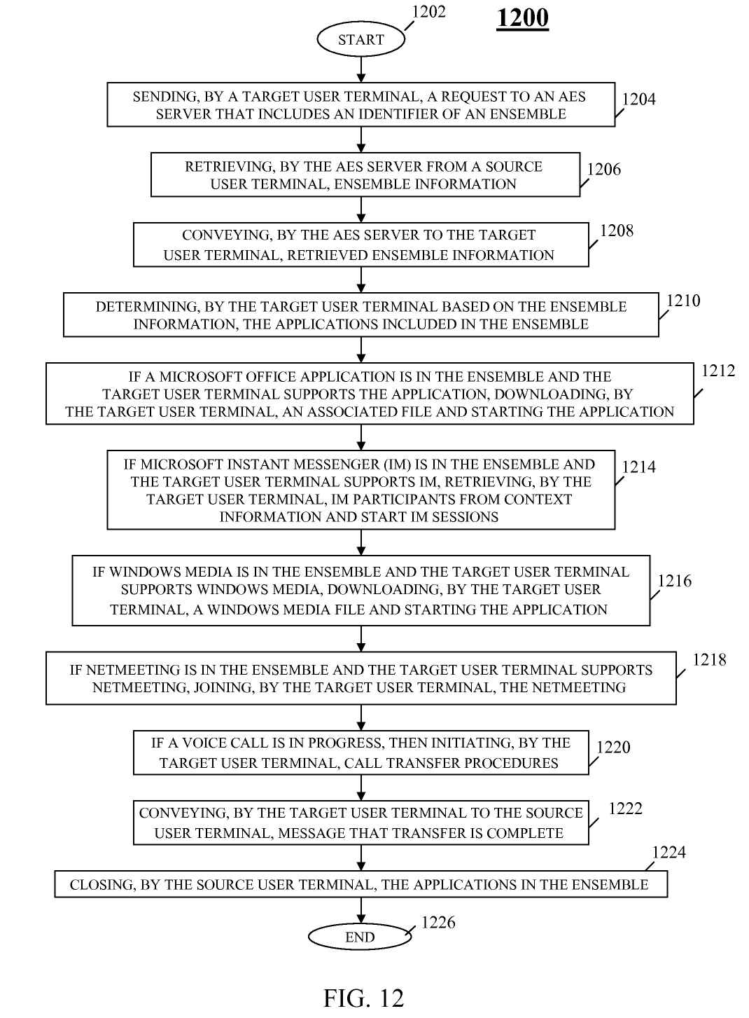

Referring now to FIG. 12, a logic flow diagram 1200 is provided that illustrates the pulling of an ensemble of applications by a target user terminal from a source user terminal, from the perspective of the user terminals, in accordance with the another embodiment of the present invention. Logic flow diagram 1200 begins (1202) when an AES client 306 at the target user terminal, that is, user terminal 105, sends (1204) a request to AES server 124 that includes an identifier of an ensemble. AES server 124 maintains, or retrieves from subscriber profile database 116, an association between ensembles and user terminals and, based on the identifier, the AES server retrieves (1206), from an AES client 306 of a source user terminal, for example, user terminal 103, and the source user terminal AES client conveys to the AES server, ensemble information elements associated with the requested ensemble. AES server 124 then conveys (1208) to an AES client 306 of the target user terminal, and the target user terminal AES client receives (1208) from the AES server, the ensemble information elements.

In response to receiving the ensemble information elements, the AES client 306 of the target user terminal determines (1210) the applications included in the ensemble. For example, if the ensemble includes a Microsoft Office application and the target user terminal supports the Microsoft Office application, AES client 306 of the target user terminal, based on the received ensemble information elements, may download (1212) an associated file or files (for example, a Word document or an Excel spreadsheet) from the network repository if the file is not available locally and starts up the application. If the ensemble includes an Instant Messenger (IM) application and the target user terminal supports IM, then AES client 306 of the target user terminal, based on the received ensemble information elements, may retrieve (1214) a list of participants from the received context elements and start one or more IM sessions. If the ensemble includes a Windows Media application and the target user terminal supports Windows Media, then AES client 306 of the target user terminal may download (1216), based on the received ensemble information elements, the file from the network repository if the file is not available locally. If the ensemble includes a NetMeeting application and the target user terminal supports NetMeeting, AES client 306 of the target user terminal may retrieve (1218), based on the received ensemble information elements, the address of the NetMeeting host and join the meeting. If the ensemble includes (1220) a voice session, then AES client 306 of the target user terminal may initiate a call transfer based on the received ensemble information elements.

After the transfer of the ensemble of applications is complete, AES client 306 of the target user terminal informs (1222) AES client 306 of the source user terminal that the transfer is complete. In response to being informed that the transfer is complete, AES client 306 of the source user terminal closes (1224) the applications in the ensemble and logic flow 1200 then ends (1226).

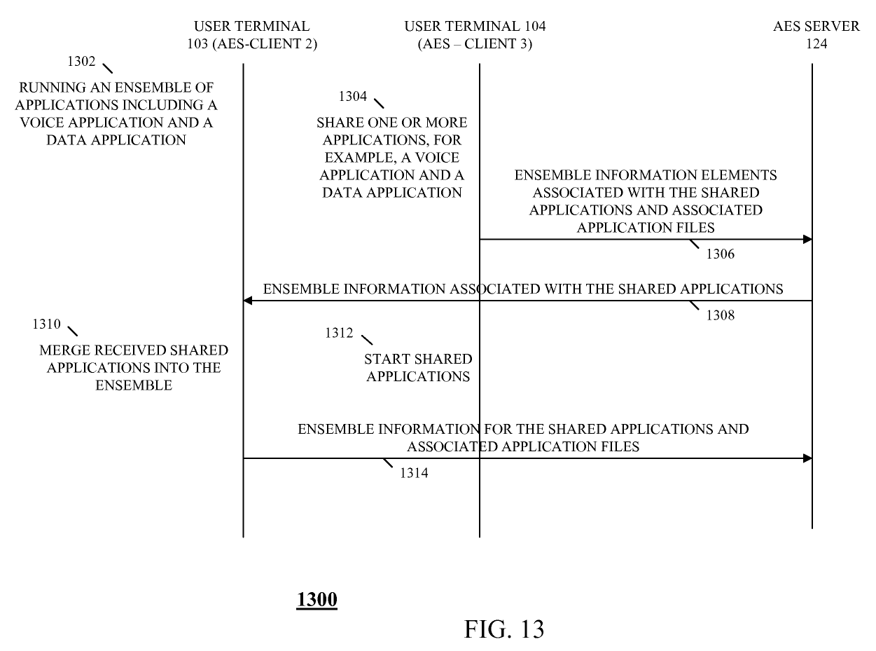

Referring now to FIG. 13, a signal flow diagram 1300 is provided that illustrates a copying of one or more applications of an application ensemble from a source user terminal to a target user terminal without removing the copied applications from the ensemble at the source user terminal in accordance with another embodiment of the present invention. Signal flow diagram 1300 begins when a user terminal 103 is running (1302) an ensemble of applications. The users of user terminals 103 and 104 then decide to copy one or more applications and files of the ensemble from a source user terminal, that is, user terminal 104, to a target user terminal, that is, user terminal 103, for example, in order to share the applications and files. As described in detail above, in creating an application ensemble, the AES client 306 of a user terminal stores, in at least one memory device 304 of the user terminal and in association with each other, information elements that identify the applications and that further identify a context of each such application, such as a state of each such application or associated file. In addition, in response to creating an ensemble, the AES client 306 of each user terminal may inform AES server 124 of the active ensemble.

The user of user terminal 104 instructs (1304) the user terminal to share, with user terminal 103, one or more applications of an ensemble of applications associated with on user terminal 104. For example, the user of user terminal 104 may input a share instruction by touching a transfer softkey on a display screen 310 of the user terminal. In response to receiving the transfer instruction, AES client 306 of user terminal 104 displays, on display screen 310, a list of applications in the ensemble of user terminal 104 and may further identify files associated with the applications. The user of user terminal 104 then inputs a selection of the applications and/or files to be shared. AES client 306 of user terminal 104 further displays a list of other user terminals accessible by user terminal 104, for example, an address book of user terminal 104 that is maintained in the at least one memory device 304 of the user terminal, and the user of user terminal 104 then inputs a selection of a user terminal, that is, user terminal 103, as the destination terminal for the shared applications.

In response to receiving the instruction to share ensemble applications and the destination selection, AES client 306 of user terminal 104 retrieves ensemble information elements associated with the applications and associated files to be shared and an identifier associated with user terminal 103 from at least one memory device 304 of the user terminal and conveys (1306) the retrieved ensemble information elements and identifier, as well as an identifier of the source of the transfer, that is, user terminal 104, to AES server 124. AES client 306 of user terminal 104 further may upload any associated files to AES server 124 or another known network repository if such files are not included in the ensemble information elements. AES server 124 then forwards (1308) the ensemble information elements and identifiers of user terminals 103 and 104 to AES client 306 of user terminal 103.

In response to receiving the ensemble information elements from AES server 124, AES client 306 of user terminal 103 stores the received ensemble information elements and user terminal 104 identifier in at least one memory device 304. AES client 306 of user terminal 103 further starts up (1310) the shared applications and opens the shared files, downloading the files if necessary, based on the ensemble information elements received from AES server 124 and merges them into the ensemble of applications displayed at user terminal 103. For example, if one of the suspended applications is a voice application, AES client 306 of user terminal 103 sets up (1310, 1312) a voice session with user terminal 104 via AES server 124 based on the received information elements and as described above in greater detail. In addition, the AES clients 306 of user terminals 103 and 104 start up (1310, 1312) applications and files corresponding to the shared applications based on the retrieved/transferred ensemble information elements. Thus, a transferred data application, for example, a Word document, may be shared with, and modified by, a user of user terminal 103 while the document is discussed via the established voice session.

When the communication session is over, AES client 306 of user terminal 103 closes the shared applications and files and conveys (1314) ensemble information elements associated with the applications and files, such an identifier associated with the transferred applications and context, such as status, information for each such application and associated file, along with an identifier of the source of the application transfer, that is, user terminal 104, to AES server 124. AES client 306 of user terminal 103 may further upload the shared files to AES server 124 or another known network repository if such files are not included in the ensemble information elements. Signal flow diagram 1300 then ends.

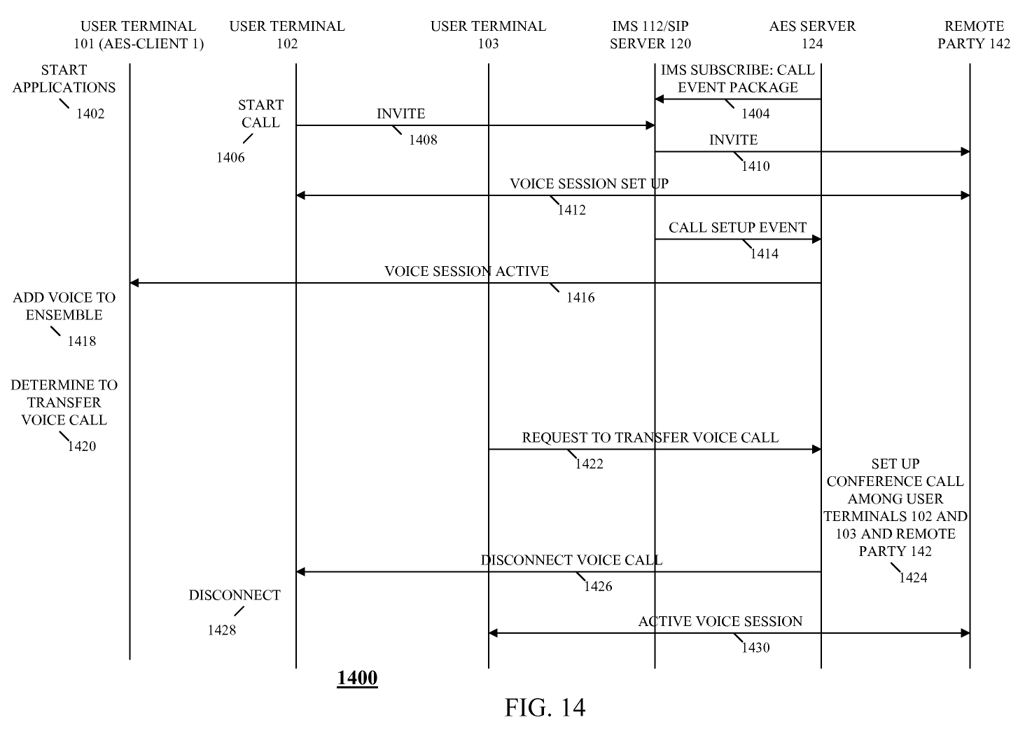

Referring now to FIG. 14, a signal flow diagram 1400 is provided that illustrates a transfer of a voice session from one voice terminal to another voice terminal in accordance with another embodiment of the present invention, wherein the voice session is part of an application ensemble. Similar to signal flow diagram 500, signal flow diagram 1400 begins when a local user starts up a multimedia session with remote party 142. More particularly, the user starts up (1402) one or more data applications, for example, Microsoft® NetMeeting®, Word®, and Excel® on a first user terminal 101 and initiates (1406) a call to remote party 142 on a second user terminal 102. AES client 306 of user terminal 101 further registers with AES server 124. Concurrent with, or prior to, starting up the multimedia session and in response to the registration of user terminal 101, AES server 124 requests (1404) that CSCF 114, and in particular the S-CSCF, inform the AES server of any call event involving associated user terminal 102. Preferably, the request by AES server 124 comprises an IMS SUBSCRIBE: CALL EVENT PACKAGE message that identifies user terminal 102, preferably by conveying an identifier associated with the user terminal, and that requests information concerning any call event involving the user terminal.

In response to the user of user terminal 102 initiating the call, user terminal 102 conveys (1408) a session invitation intended for remote party 142, preferably a SIP INVITE, to IMS core network 112. The session invitation is routed to SIP server 120 and the SIP server forwards (1410) the session invitation to remote party 142. When the remote party accepts the session invitation, a voice session is then set up (1412) in accordance with well-known techniques, and CSCF 114, and in particular the S-CSCF, informs (1414) AES server 124 that a call has been set up between user terminal 102 and remote party 142. Preferably, CSCF 114 informs AES server 124 of the call by conveying a CALL SETUP EVENT message, preferably an IMS: EVENT: CALL message, to the AES server. The CALL SETUP EVENT message includes information pertinent to the voice call, including a source (user terminal 102) identifier and a destination (remote party 142) identifier.

In response to being informed that a voice call has been set up between user terminal 102 and remote party 142, AES server 124 then informs (1416) AES client 306 of user terminal 101 of the call, preferably by conveying a VOICE SESSION ACTIVE message to the AES client of the user terminal 101 that informs of an active voice session between user terminal 102 and remote party 142, including providing the identifiers of user terminal 102 and remote party 142. In response to being informed of the voice call between user terminal 102 and remote party 142, the AES client 306 of user terminal 101 creates (1418) an application ensemble by storing, in the at least one memory device of user terminal 101 and in association the data application running on the user terminal, the voice session information received from AES server 124.

Subsequent to creating the ensemble, the user of user terminal 103 determines (1420) to transfer the voice session from user terminal 102 to a third user terminal 103. The user inputs an instruction to user terminal 103 to transfer the voice session that is included in the ensemble. In response to the instruction, AES client 306 of user terminal 103 conveys (1422), to AES server 124, a request to set up a third party call control initiated call with user terminal 102 and remote party 142. In response to receiving the request, AES server 124 reserves a conference call bridge from a conference call platform, if needed, and sets up (1424) a third party call control initiated call among user terminals 102 and 103 and remote party 142. AES server 124 then instructs (1426) AES client 306 of user terminal 102 to disconnect from the call. In response to receiving the instruction, user terminal 102 disconnects (1428) from the call while user terminal 103 and remote party 142 maintain an active voice session (1430) and signal flow diagram 1400 ends.

By providing an AES server 124 that interfaces with AES clients 306 running on user terminals, communication system 100 is able to collectively manage an application ensemble comprising multiple applications that may be running on multiple user terminals. Communication system 100 allows a user to collectively transfer the ensemble from a source terminal or terminals to a target terminal or terminals, for example, from voice and data terminals to other voice and data terminals or to a single user terminal. Communication system 100 further allows the user to selectively transfer applications of the ensemble, such as transferring only the voice session from the voice terminal to another voice or voice/data terminal, and to copy an ensemble, or a portion of an ensemble, from a source terminal to a target terminal, wherein the ensemble or portion of the ensemble is not removed from the source terminal. Communication system 100 further allows a user to suspend and resume an application ensemble, which application may be resumed at a source user terminal or at a target user terminal. By allowing a user to collectively suspend, resume, copy, and transfer an application ensemble, communication system 100 provides the user with a simple and seamless ability to take a multimedia communication session with him or her when changing locations, for example, when leaving an office and continuing the session in his/her car or at his/her home.

While the present invention has been particularly shown and described with reference to particular embodiments thereof, it will be understood by those skilled in the art that various changes may be made and equivalents substituted for elements thereof without departing from the scope of the invention as set forth in the claims below. Accordingly, the specification and figures are to be regarded in an illustrative rather then a restrictive sense, and all such changes and substitutions are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any variation thereof, are intended to cover a non-exclusive inclusion, such that a process, method, article, or apparatus that comprises a list of elements does not include only those elements but may include other elements not expressly listed or inherent to such process, method, article, or apparatus. The terms “including” and/or “having,” as used herein, are defined as comprising. The term “coupled,” as used herein, is defined as connected, although not necessarily directly, and not necessarily mechanically. An element preceded by “ . . . a” does not, without more constraints, preclude the existence of additional identical elements in the process, method, article, or apparatus that the element. Furthermore, unless otherwise indicated herein, the use of relational terms, if any, such as first and second, top and bottom, and the like are used solely to distinguish one entity or action from another entity or action without necessarily requiring or implying any actual such relationship or order between such entities or actions.

What is claimed is:

1. A method for management of an application ensemble comprising a plurality of applications, the method comprising:
concurrently running the plurality of applications on a plurality of user terminals associated with a same user;
collecting ensemble information for the plurality of applications;
transferring the ensemble information to a user terminal different from the plurality of user terminals; and
opening, by the user terminal different from the plurality of user terminals, the plurality of applications based on the ensemble information.

2. The method of claim 1, wherein one application of the plurality of applications is a data application running on a first user terminal of the plurality of user terminals and another application of the plurality of applications is a voice application running on a second user terminal of the plurality of user terminals.

3. The method of claim 1, wherein collecting comprises:
providing a list of active ensembles;
receiving a selection of an ensemble from the list of active ensembles; and
collecting ensemble information for a plurality of applications associated with the selected ensemble.

4. The method of claim 1, wherein collecting comprises:
providing a list comprising the plurality of applications included in the ensemble;
receiving a selection of multiple applications of the plurality of applications; and
collecting ensemble information associated with the selected applications.

5. The method of claim 1, wherein transferring comprises:
uploading, by one or more user terminals of the plurality of user terminals and to a network repository, a file associated with an application of the plurality of applications; and
downloading, by the user terminal different from the plurality of user terminals and based on the ensemble information, the uploaded file from the network repository.

6. A method for management of an application ensemble comprising a plurality of applications, the method comprising:
concurrently running a plurality of applications on one or more user terminals associated with a same user;
initiating, by a user terminal different from the one or more user terminals, a transfer of the plurality of applications; and
transferring the plurality of applications to the user terminal different from the one or more user terminals.

7. The method of claim 6, wherein transferring comprises:
collecting ensemble information for the plurality of applications;
transferring the ensemble information to the user terminal different from the one or more user terminals; and
opening, by the user terminal different from the from the one or more user terminals, the plurality of applications based on the ensemble information.

8. The method of claim 6, wherein the plurality of applications comprises a data application and a voice application.

9. The method of claim 6, wherein initiating comprises requesting a list of active application ensembles.

10. The method of claim 9, wherein transferring comprises:
providing the list of active application ensembles;
receiving a selection of an application ensemble from the list of active application ensembles; and
transferring the selected application ensemble to the user terminal different from the plurality of user terminals.

11. The method of claim 10, wherein transferring the selected ensemble comprises:
requesting, from a server, the selected ensemble;
retrieving, by the server, ensemble information associated with the selected ensemble; and
conveying the retrieved ensemble information to the user terminal different from the plurality of user terminals.

12. The method of claim 6, wherein transferring comprises:
uploading, by the one or more user terminals and to a network repository, a file associated with an application of the plurality of applications; and
downloading, by the user terminal different from the one or more user terminals and based on the ensemble information, the uploaded file from the network repository.

13. An apparatus for managing an application ensemble comprising a plurality of applications, the apparatus comprising a network server configured to collect ensemble information for a plurality of applications concurrently running on a plurality of user terminals associated with a same user and transfer the ensemble information to a user terminal different from the plurality of user terminals.

14. The apparatus of claim 13, wherein one application of the plurality of applications is a data application running on a first user terminal of the plurality of user terminals and another application of the plurality of applications is a voice application running on a second user terminal of the plurality of user terminals.

15. The apparatus of claim 14, wherein the apparatus further comprises the first user terminal and wherein the first user terminal is configured to provide, to a user, a list comprising the plurality of applications included in the ensemble, receive a selection of multiple applications of the plurality of applications, and convey the selection to the network server.

16. The apparatus of claim 14, wherein the voice application is associated with a voice session between the second user terminal and a remote party and wherein the apparatus further comprises the user terminal different from the plurality of user terminals, which user terminal receives the ensemble information from the network server and sets up a voice session with the remote party based on the ensemble information.

17. The apparatus of claim 13, wherein the network server further is configured to provide a user terminal of the plurality of user terminals with a list of active ensembles, receive a selection of an ensemble from the list of active ensembles, and collect ensemble information for a plurality of applications associated with the selected ensemble.

18. An apparatus for managing an application ensemble comprising a plurality of applications concurrently running on one or more user terminals associated with a same user, the apparatus comprising a network server configured to receive, from a user terminal different from the one or more user terminals, a request to initiate a transfer of the plurality of applications and to transfer the plurality of applications to the user terminal different from the one or more user terminals.

19. The apparatus of claim 18, wherein the network server is configured to transfer the plurality of applications by collecting ensemble information for the plurality of applications and transfer the ensemble information to the user terminal different from the one or more user terminals.

20. The apparatus of claim 18, wherein the plurality of applications comprises a data application and a voice application.

21. The apparatus of claim 18, wherein the request to initiate a transfer of the plurality of applications comprises a request for a list of active application ensembles.

22. The apparatus of claim 21, wherein the network server is configured to transfer the plurality of applications by providing the list of active application ensembles to the user terminal different from the one or more user terminals, receiving a selection of an application ensemble from the list of active application ensembles from the user terminal different from the one or more user terminals, and transferring the selected application ensemble to the user terminal different from the plurality of user terminals.

23. The apparatus of claim 18, wherein the network server is configured to retrieve ensemble information associated with the selected ensemble from the one or more user terminals.
